(19) United States
(12) Patent Application Publication
(10) Pub. No.: US 2017/0047593 A1
(43) Pub. Date: Feb. 16, 2017

(54) Battery with Corrosion-Resistant Ion-Exchange Membrane System

(71) Applicant: Sharp Laboratories of America, Inc., Camas, WA (US)

(72) Inventors: Yuhao Lu, Vancouver, WA (US); Sean Vail, Vancouver, WA (US)

(21) Appl. No.: 15/339,769

(22) Filed: Oct. 31, 2016

Related U.S. Application Data
(63) Continuation-in-part of application No. 13/564,015, filed on Aug. 1, 2012, now Pat. No. 9,537,192.

(51) Int. Cl. H01M 8/0204; H01M 8/18; H01M 8/04276; H01M 8/08; H01M 8/14; H01M 8/20; H01M 8/1067

(52) U.S. Cl. CPC H01M 8/0204; H01M 8/20; H01M 8/188; H01M 8/1067; H01M 8/08; H01M 8/143; H01M 8/04276

(57) ABSTRACT

A battery with a corrosion-resistant ion-exchange membrane system is presented. The battery has an acidic catholyte, an anode metal that is chemically reactive towards water, and an ion-exchange membrane system. Some examples of anode metals include alkali metals, alkaline earth metals, and aluminum (Al). The ion-exchange membrane system includes a solid, cation-permeable, water-impermeable first membrane adjacent to the anode, prone to decomposition upon chemical reaction with an acid, an anion-permeable second membrane adjacent to the cathode, and a buffer compartment including a solution, interposed between the first membrane and the second membrane. In response to discharging the battery, the solution in the buffer compartment accepts cations from the anode and anions from the cathode, forming a cation-anion salt solution in the buffer compartment. The second membrane prevents the transportation of protons from the catholyte to the buffer compartment, and so prevents the corrosion of the first membrane.

### RELATED APPLICATION

The application is a Continuation-in-Part of a pending application entitled, BATTERY WITH LOW TEMPERATURE MOLTEN SALT (LTMS) CATHODE, invented by Yuhao Lu et at, Ser. No. 13/564,015, filed on Aug. 1, 2012, Attorney Docket No. SLA3165, which is incorporated herein by reference.

### BACKGROUND OF THE INVENTION

1. Field of the Invention

This invention generally relates to electrochemical cells and, more particularly, to a low temperature molten salt battery with a corrosion-proof separator system.

2. Description of the Related Art

Flow-through batteries have been intensively studied and developed for large-scale energy storage due to their long cycle life, flexible design, and high reliability. A battery is an electrochemical device in which ions (e.g. metal-ions, hydroxyl-ions, protons, etc.) commute between the anode and cathode to realize energy storage and conversion. In a conventional battery, all the components including the anode materials, cathode materials, separator, electrolyte, and current collectors are contained within a volume-fixed compartment. Consequently, the battery's corresponding energy and capacity are fixed according to this configuration. A flow-through battery consists of current collectors (electrodes) separated by an ion-exchange membrane, while at least one of the anode or cathode materials are present in a separate storage tank. These materials are circulated through the flow-through battery in which electrochemical reactions take place to deliver and to store energy. Therefore, the battery capacity and energy are determined by (1) the type of anode and cathode active materials, and (2) the concentrations of anode and cathode active material.

A low temperature molten salt (LTMS) may be used as a cathode (catholyte) for rechargeable batteries operating at temperatures of less than 150° C., as described in the above-referenced parent application Ser. No. 13/564,015, which demonstrated high capacity solution-based catholytes and slurry cathodes.

TABLE 1
Properties of LTMS electrode materials

| | | Potential | Molecular | Specific |
|---|---|---|---|---|
| | Redox | (V) vs. | weight | capacity |
| Compound | Couple | Li/Li⁺ | (g/mol) | (mAh/g) |
| Mn(NO₃)₃•6H₂O | Mn^{3+/2+} | 4.54 | 349.07 | 76.79 |
| Mn(NO₃)₂•4H₂O | | | 251.03 | 106.78 |
| MnCl₂•4H₂O | | | 197.92 | 135.44 |
| FeBr₃•6H₂O | Fe^{3+/2+} | 3.81 | 403.68 | 66.40 |
| KFe(SO₄)₂•12H₂O | | | 503.31 | 53.26 |
| FeCl₃•6H₂O | | | 270.32 | 99.16 |
| Fe(NO₃)₃•9H₂O | | | 404.04 | 66.34 |
| FeCl₃•2H₂O | | | 198.24 | 135.22 |
| Fe(NO₃)₂•6H₂O | | | 287.98 | 93.08 |
| FeSO₄•7H₂O | | | 278.05 | 96.41 |
| CoSO₄•7H₂O | Co(H₂O)₆^{3+/2+} | 4.96 | 281.14 | 95.35 |
| Co(NO₃)₂•6H₂O | | | 291.06 | 92.10 |

FIGS. 1A through 1D depict characteristics of a lithium (Li) anode LTMS battery with a conventional separator (prior art). Due to the fact that crystal water is introduced by the molten salts, water-reactive alkali metals cannot be used in LTMS batteries that utilize a conventional cell structure. As proof of demonstration, a lithium-ion permeable, water-impermeable solid electrolyte (SE) [e.g. Li₁₊ₓAlₓTi₂₋ₓ(PO₄)₃ (LATP)] was used to separate the alkali (Li) metal anode from LTMS catholyte, as shown in FIG. 1A. FIG. 1B shows the cell's charge/discharge behaviors in the voltage range from 3.3V to 4.1V. Although it was confirmed that the battery demonstrated good reversibility, its capacity gradually decayed in 51 cycles. Following disassembly of the cell and inspection of the LATP solid electrolyte, severe corrosion was revealed, as illustrated in FIG. 1C. FIG. 1D depicts the corresponding XRD patterns for both a pristine and tested (following battery operation) LATP SE. Upon comparison of the two patterns, it can be noted that several new peaks appeared at low angles. The two peaks at 21.32 and 21.39 degrees for the pristine SE merged together after it was tested in the battery. In addition, the 100% intensity peak changed from 25.08 degrees (before testing) to 21.32 degrees for the SE after testing. Above 40 degrees, the peaks for the two LATP SEs were very similar while no other new peaks were observed. After battery testing, the LATP SE showed three new peaks at 14.19, 16.99, and 18.71 degrees. Upon consulting the XRD database, it was determined that the derivatives may include Li₃Ti₂(PO₄)₃ (peaks at 14.44 (100%) and 19.74 (88%) degrees, LiTiP₂O₇ (peak at 17.26 (100%) degrees), FeOOH (Cmcm space group, peak at 14.12 (100%) degrees), and LiPO₃(P121/c1 space group, 18.70 (100%) degrees). At the same time, no FeCl₃, LiCl, or Fe(OH)₃ were observed on the SE surface. Regardless, the appearance of new peaks indicated the unstable properties of LATP in the above-described system.

The fundamental reason for the LATP corrosion is the strongly acidic environment arising from the hydrolysis of molten salts. For example, FeCl₃.6H₂O═Fe(OH)₃+3Cl⁻+3H⁺+3H₂O. Generally, Li⁺-solid conductors, including LATP, Li₇La₃Zr₂O₁₂ (LLZO), LiLa_{2/3-x}TiO₃ (LLTO), LiₓPO_{y}N_{z} (LiPON), or Li₁₀GeP₂O₁₂ (LGPS), cannot persevere in such acidic environments without corrosion.

In order to improve the battery stability, especially for LATP stability in acidic solutions, some strategic methods could be adopted. For example, buffer solutions can be used to modulate the pH value of the LTMS catholyte. Alternatively, polymer electrolytes could be used to modify the solid electrolyte surface to retard its corrosion/decomposition. Otherwise, inorganic compounds (e.g., TiN) could be coated onto the solid electrolyte surface to suppress corrosion. However, these solutions add complexity to the battery and their full consequences are not completely understood.

It would be advantageous if the cell structure of an alkali metal/LTMS catholyte battery could be modified to prevent the corrosion of the SE separator and improve battery performance.

### SUMMARY OF THE INVENTION

Disclosed herein is a new cell structure for alkali metal low temperature molten salt (LTMS) batteries to improve their stability during cycling. The cell consists of three primary compartments which include: (1) an anode compartment containing an alkali metal, alkaline earth metal, or aluminum, (2) a cathode compartment containing a catholyte (e.g., LTMS), and (3) a buffering space. The buffering space is located between the anode and cathode compartments. A cation-permeable solid electrolyte separates the anode compartment and the buffering space, while an anion permeable membrane is interposed between the cathode compartment and the buffering space. Following at least one charge/discharge cycle, the buffering space becomes filled with a cation-anion salt solution. In one aspect, the LTMS catholyte can be refreshed by employing a flow-through mode cathode compartment. Advantageously, lithium (Li)/LTMS batteries can operate at temperatures below 100° C.

Accordingly, a method is provided for transporting ions in a battery having a corrosion-resistant ion-exchange membrane system. The method is applied to a battery with a cathode including an acidic catholyte, an anode including a metal that is chemically reactive towards water, and an ion-exchange membrane system. Some examples of anode metals include alkali metals, alkaline earth metals, and aluminum (Al). The ion-exchange membrane system includes a solid, cation-permeable, water-impermeable first membrane adjacent to the anode, prone to decomposition upon chemical reaction with an acid, an anion-permeable second membrane adjacent to the cathode, and a buffer compartment including a solution. The ion-exchange membrane system is interposed between the first membrane and the second membrane. During discharging of the battery, the solution in the buffer compartment accepts cations from the anode and anions from the cathode, forming a cation-anion salt solution in the buffer compartment.

The first membrane permits both the transport of cations from the anode to the buffer compartment, and prevents the transportation of anions from the buffering compartment to the anode. Some examples of first membrane materials include Li_{1+X}Al_{X}Ti_{2-X}(PO₄)₃ (LATP), Li₇La₃Zr₂O₁₂ (LLZO), Li_{X}PO_{Y}N_{Z} (LiPON), LiₓLa_{2/3-x}TiO₃ (LLTO), Li₁₀GeP₂O₁₂ (LGPS), Na₂M₂TeO₆, beta-alumina, Na₁₊ₓZr₂SiₓP₃₋ₓO₁₂, metal-organic frameworks (MOFs), (1−x)Mg(NO3)2−xAl2O3, magnesium zirconium phosphates, Al₂(WO₄)₃, KSbO₃, NaSbO₃, K₁₋ₓAl₁₋ₓRₓO₂, and NaₓAl_{y}R_{z}O₂, where M is a transition metal, and where R may be silicon (Si), germanium (Ge), or titanium (Ti). The second membrane acts to prevent the transportation of cations from the buffer compartment to the cathode, as well as preventing the transportation of protons (Elk) from the catholyte to the buffer compartment. As a result of preventing the transfer of the protons from the catholyte to the buffer compartment, corrosion of the first membrane is inhibited.

In one aspect, the catholyte is a low temperature molten salt (LTMS). Some examples of a LTMS catholyte include FeCl₃.6H₂O and LiNO3, and FeCl₃.6H₂O and LiCl, Mn(NO₃)₃.6H₂O, Mn(NO₃)₂.4H₂O, MnCl₂.4H₂O, FeBr₃.6H₂O, KFe(SO₄)₂.12H₂O, FeCl₃.6H₂O, Fe(NO₃)₃.9H₂O, FeCl₃.2H₂O, Fe(NO₃)₂.6H₂O, FeSO₄.7H₂O, CoSO₄.7H₂O, Co(NO₃)₂.6H₂O, Ni(NO₃)₂.6H₂O, Cd(NO₃)₂.4H₂O, and Cd(NO₃)₂.H₂O. The battery has an operating voltage range responsive to the pH value of the LTMS, which is less than 7. Advantageously, the battery (LTMS catholyte) has a liquid phase operating temperature of less than 100 degrees C.

Additional details of the above-described method and a battery having a corrosion-resistant ion-exchange membrane system are provided below.

### BRIEF DESCRIPTION OF THE DRAWINGS

FIGS. 1A through 1D depict characteristics of a lithium (Li) anode LTMS battery with a conventional separator (prior art).

FIG. 2 is a partial cross-sectional view of a battery with a corrosion-resistant ion-exchange membrane system.

FIG. 3 is a flowchart illustrating method for transporting ions in a battery having a corrosion-resistant ion-exchange membrane system.

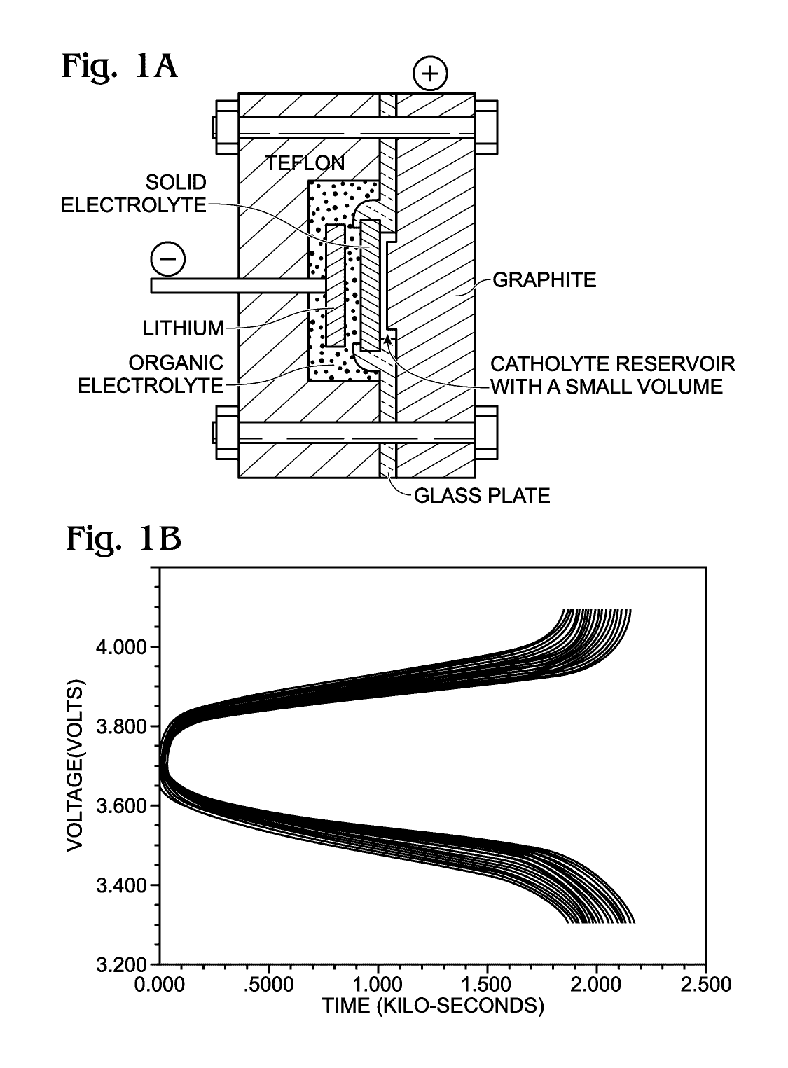

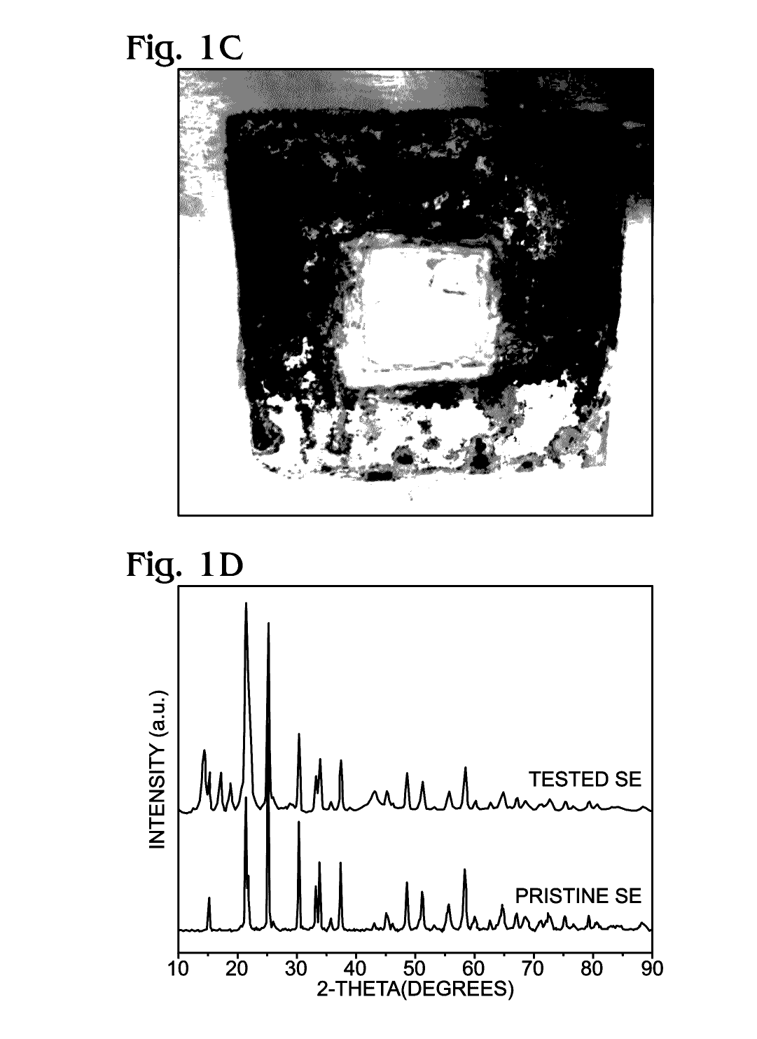

### DETAILED DESCRIPTION

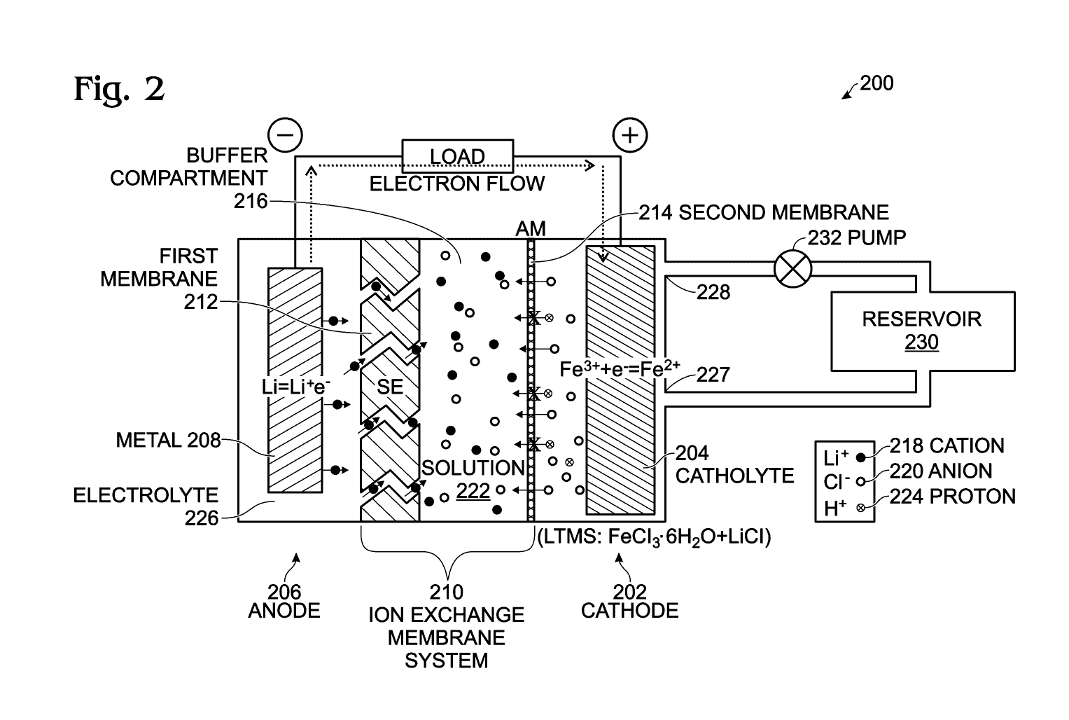

FIG. 2 is a partial cross-sectional view of a battery with a corrosion-resistant ion-exchange membrane system. The battery 200 comprises a cathode 202 with an acidic catholyte 204. The battery 200 also comprises an anode 206 with a metal 208 that is chemically reactive towards water. An ion-exchange membrane system 210 comprises a solid, cation-permeable, water-impermeable first membrane 212 adjacent to the anode 206, prone to decomposition upon chemical reaction with an acid. The first membrane 212 may also be referred to as a solid electrolyte (SE). Note: the drawing is not to scale.

An anion-permeable second membrane (AM) 214 is adjacent to the cathode 202. A buffer compartment 216 is interposed between the first membrane 212 and the second membrane 214, and comprises a solution 222 of material including cations 218 from the anode 206 and anions 220 from the cathode 202. Note: the cations and anions may only be present in the solution 222 in the buffer compartment after the battery 200 completes at least one charge/discharge cycle. In some aspects, the solution 222 (e.g., water or non-aqueous electrolyte) may contain no cations or anions prior to the initial charge/discharge cycle.

The first membrane 212 prevents the transportation of anions 220 from the buffer compartment 216 to the anode 206. The second membrane 214 prevents the transportation of cations 218 from the buffer compartment 216 to the cathode 202. The second membrane 214 also prevents the transportation of protons 224 from the catholyte 204 to the buffer compartment 216. As a result of preventing the transfer of the protons (also referred to as hydrons (H⁺)) 224 to the buffer compartment 216, corrosion of the first membrane 212 is prevented.

In one aspect as shown, an anode 206 is configured as a compartment with an electrolyte 226. However, the electrolyte is not always necessary if the anode metal 208 directly abuts the first membrane 212. Some examples of first membrane materials include Li_{1+X}Al_{X}Ti_{2-X}(PO₄)₃ (LATP), Li₇La₃Zr₂O₁₂ (LLZO), Li_{X}PO_{Y}N_{Z} (LiPON), LiₓLa_{2/3-x}TiO₃ (LLTO), Li₁₀GeP₂O₁₂ (LGPS), Na₂M₂TeO₆, beta-alumina, Na₁₊ₓZr₂SiₓP₃₋ₓO₁₂, metal-organic frameworks (MOFs), (1−x)Mg(NO3)2−xAl2O3, magnesium zirconium phosphates, Al₂(WO₄)₃, KSbO₃, NaSbO₃, K₁₋ₓAl₁₋ₓRₓO₂, and NaₓAl_{y}R_{z}O₂;

where M is a transition metal; and,

where R is silicon (Si), germanium (GO, or titanium (Ti). In addition, the solid electrolyte first membrane may be a derivative of one of the above-listed materials, as these materials may be doped with elements such as aluminum (Al), magnesium (Mg), niobium (Nb), tantalum (Ta) and similar metals. Typically, the anode metal 208 is an alkali metal, alkaline earth metal, or aluminum (Al).

In one aspect as shown, the cathode 202 is configured as a cathode compartment containing a low temperature molten salt (LTMS) catholyte 204. Some examples of a LTMS catholyte 204 include FeCl₃. 6H₂O and LiNO3, and FeCl₃.6H₂O and LiCl, Mn(NO₃)₃.6H₂O, Mn(NO₃)₂.4H₂O, MnCl₂.4H₂O, FeBr₃.6H₂O, KFe(SO₄)₂.12H₂O, FeCl₃.6H₂O, Fe(NO₃)₃.9H₂O, FeCl₃.2H₂O, Fe(NO₃)₂.6H₂O, FeSO₄.7H₂O, CoSO₄.7H₂O, Co(NO₃)₂.6H₂O, Ni(NO₃)₂.6H₂O, Cd(NO₃)₂.4H₂O, and Cd(NO₃)₂.H₂O.

With a LTMS as the catholyte, the battery 200 has a liquid phase operating temperature of less than 100 degrees C. The operating voltage range is responsive to the pH value of the LTMS, which is less than 7. The operating voltage range is a defined range in which the battery is able to be charged and discharged. During discharge, a metal anode is oxidized to metal ions and the ions in the catholyte are reduced from a high valence to a lower valance. During charge, this process is reversed. As used herein, “chemically reactive” refers to a scenario wherein a species can be transformed via chemical interaction(s) with one or more different species to form a new species that is chemically distinct from any of the original species. As used herein, “decompose” refers to a chemical transformation of species (such as those that constitute the first membrane 212) via chemical reaction with another species (such as a proton) and through which chemical composition(s) and/or physical properties are altered relative to the original such that performance (within the context of the intended function) is reduced relative to the original. Such decomposition may be catalyzed through chemical reaction with another chemical species.

Optionally as shown, the cathode 202 is a flow-through cathode. The cathode compartment has an input flow port 227, and an output flow port 228. A reservoir 230 containing LTMS catholyte is connected to the input 227 and output 228 flow ports. As another option, a pump 232 may be connected between the cathode compartment 202 and the reservoir 230 to supply a flow of LTMS catholyte from the reservoir in response to the LTMS catholyte 204 in the cathode compartment becoming discharged below a minimum threshold voltage, or the LTMS catholyte in the cathode compartment becoming charged above a maximum threshold voltage.

In the example shown, the anode metal 208 is lithium (Li), the catholyte (LTMS) 204 is FeCl₃.6H₂O and LiCl, the cations 218 are Li⁺, the anions 220 are Cl⁻, and the protons 224 are H⁺.

As noted, the battery cell structure is not limited to only the LTMS catholyte battery shown, but may also be adopted for use in other batteries containing water-sensitive/reactive anodes and water-based cathodes/catholytes separated by an acid-sensitive solid ionic electrolyte membrane 212. The cell structure includes at least three compartments. A first compartment 202 contains the LTMS catholyte 204 as the battery cathode. A second compartment 206 contains a water-reactive metal anode 208 (alkali metal in the example shown). The third compartment (ion-exchange membrane system) 210, which is located between the cathode and anode compartments, functions as a buffering space. An alkali-ion solid electrolyte membrane 212 separates the anode compartment 206 and the buffer compartment 216, while an anion permeable membrane 214 separates the cathode compartment 202 from the buffer compartment 216. The battery 200 can be operated at temperatures of 100° C. or lower, since the liquid phase operating temperature of the LTMS catholyte is 100° C. or lower. In general, the LTMS catholyte is acidic due to the reaction of metal-ion hydrolysis. In fact, all Li⁺-solid conductors, such as LATP, Li₇La₃Zr₂O₁₂ (LLZO), LiₓLa_{2/3-x}TiO₃ (LLTO), LiₓPO_{y}N_{z}(LiPON) and Li₁₀GeP₂O₁₂ (LGPS), are readily corroded in the acidic solutions.

The acidity of the LTMS catholyte is dependent upon the types of metal ions as well as their activity in the liquid. Aside from decomposing the solid ionic electrolyte first membrane 212, the acidic degree (or pH) of the LTMS catholyte 204 impacts the potentials of redox couples as well as its own stability. For example, if a LTMS catholyte contains Fe-ions, its hydrolysis reaction can be expressed as the following:

Fe³⁺+3H₂O═Fe(OH)₃+3H⁺; (1)

In terms of the reaction, the corresponding pH value of the solution can be derived in theory from the following:

$$pH = 1.115 - \frac{{lga}_{{Fe}^{3 +}}}{3} \qquad ( 2 )$$

whereby a_{Fe}_{³⁺} is the activity of Fe³⁺ in the liquid.

In order to evaluate the pH value due to Fe³⁺ under different conditions, four types of solutions were prepared. Sample (a) was 1M Fe(NO₃)₃ dissolved in water, Sample (b) was 1M FeCl₃ dissolved in water, Sample (c) was an LTMS catholyte consisting of FeCl₃.6H₂O and LiNO₃ (mol %:mol %=1:1), and Sample (d) was an LTMS catholyte consisting of FeCl₃.6H₂O and LiCl (mol %:mol %=1:1). At a temperature of 20.4° C., their corresponding pH values were 0.4, 1.0, −1.8, and −1.3, respectively. According to Eq. (2), the pH value of the 1M Fe³⁺ solution should be 1.15. The experimental pH values for 1M Fe(NO₃)₃ and 1M FeCl₃ solutions were in agreement with the theoretical values. The difference between the experimental and theoretical data might arise due to the effect of anions (Cl⁻ and NO₃⁻) in the solutions on the activities of Fe. Iron nitrate [Fe(NO₃)₃] solution was more acidic than iron chloride [FeCl₃] solution.

In LTMS catholytes, Fe ions react with crystal water and show a very strong acidity. The addition of lithium salts, for example LiCl and LiNO₃, significantly affect properties such as the pH values. For instance, NO₃⁻ made the liquid mixture more acidic than Cl⁻, which was very similar to their behaviors in the water solutions. Another consideration is the melting point of the molten-salt system. In general, it was observed that FeCl₃.6H₂O+LiNO₃ was not completely liquefied at room temperature and had a high viscosity while, in contrast, the FeCl₃.6H₂O+LiCl system had the appearance of a solution.

The pH value of the molten-salt catholyte determines the operating voltage range for the lithium/LTMS battery since water decomposition must be avoided in the system. According to the Nernst equation, the potential dependence of pH is

E=E^{o}−0.059 pH (3)

Therefore, the water decomposition voltages are 3.15-4.38 V and 3.12-4.35 V versus Li/Li⁺ for FeCl₃.6H₂O+LiNO₃ and FeCl₃.6H₂O+LiCl systems, respectively. Noteworthy is the fact that commercial solid electrolytes (e.g. Li_{1+x+y}AlₓTi₂₋ₓSi_{y}P_{3-y}O₁₂) are not stable in acidic solutions. Therefore, the novel cell structure disclosed herein was developed for the LTMS catholyte battery to avoid corrosion of the solid electrolyte by acidic species.

To explain the working mechanisms of the novel cell structure, a Li/FeCl₃.6H₂O LTMS battery is used as an example, as shown in FIG. 2. To prevent protons 224 from approaching and corroding the solid ionic conductor first membrane 212, an anion-exchange membrane 214 is used. Accordingly, the anion-exchange membrane 214 permits the transfer of Cl⁻-ions but blocks positively charged species, such as Li⁺-ions and H⁺-ions, from passing through the membrane.

In the Li/FeCl₃.6H₂O LTMS battery example, the anode includes a lithium metal with/without organic electrolyte. During discharge, metallic lithium is oxidized to Li⁺-ions and electrons. Li⁺-ions pass through the solid electrolyte (SE) first membrane 212 and into the buffer compartment 216. The electrons move to the cathode through the external circuit (load) and reduce Fe³⁺-ions to Fe²⁺-ions. At the same time, Cl⁻-ions move through the anion-exchange membrane (AM) 214 from the cathode compartment 202 into the buffer compartment 216 in order to neutralize charges. Due to the repulsion caused by the anion-exchange membrane 214, protons 224 are confined to the cathode compartment 202 and cannot contact with the lithium ionic conductor first membrane 212. Therefore, corrosion/decomposition of the solid electrolyte first membrane 212 by the action of protons is eliminated. As a result, the LTMS catholyte battery demonstrates stable behavior.

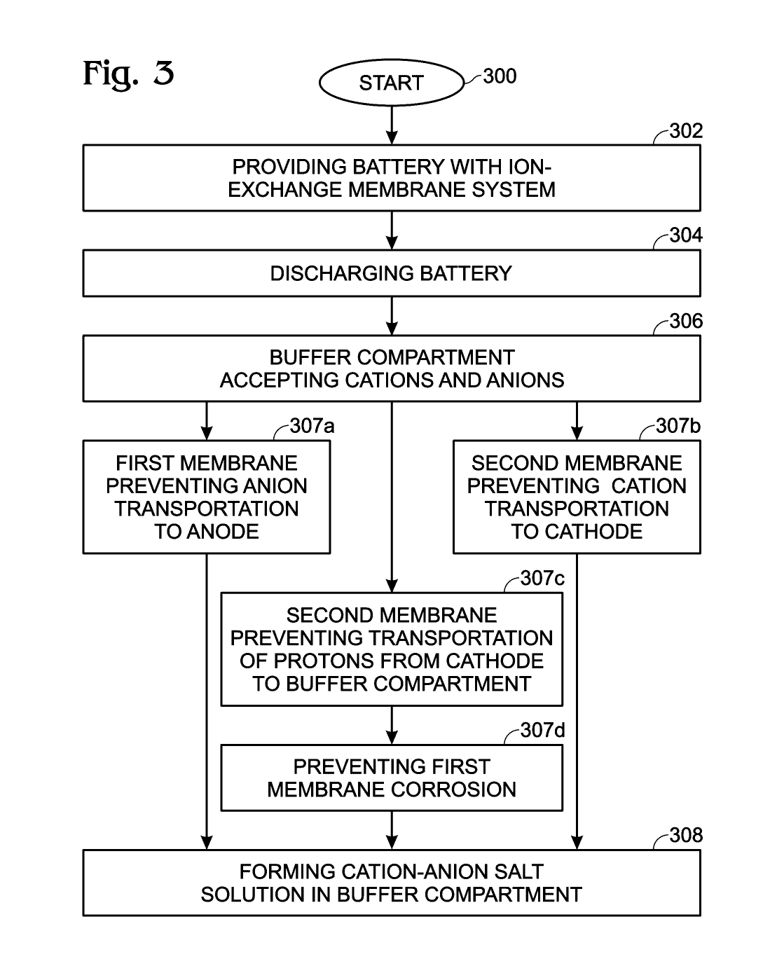

FIG. 3 is a flowchart illustrating a method for transporting ions in a battery having a corrosion-resistant ion-exchange membrane system. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 300.

Step 302 provides a battery comprising a cathode including an acidic catholyte, an anode including a metal that is chemically reactive towards water, and an ion-exchange membrane system. Some examples of anode metals include alkali metals, alkaline earth metals, and aluminum (Al). The ion-exchange membrane system comprises a solid, cation-permeable, water-impermeable first membrane adjacent to the anode, prone to decomposition upon chemical reaction with an acid, an anion-permeable second membrane adjacent to the cathode, and a buffer compartment including a solution. The ion-exchange membrane system is interposed between the first membrane and the second membrane. Some examples of first membrane materials include Li_{1+X}Al_{X}Ti_{2-X}(PO₄)₃ (LATP), Li₇La₃Zr₂O₁₂ (LLZO), Li_{X}PO_{Y}N_{Z} (LiPON), LiₓLa_{2/3-x}TiO₃ (LLTO), Li₁₀GeP₂O₁₂ (LGPS), Na₂M₂TeO₆, beta-alumina, Na₁₊ₓZr₂SiₓP₃₋ₓO₁₂, metal-organic frameworks (MOFs), (1−x)Mg(NO3)2−xAl2O3, magnesium zirconium phosphates, Al₂(WO₄)₃, KSbO₃, NaSbO₃, K₁₋ₓAl₁₋ₓRₓO₂, and NaₓAl_{y}R_{z}O₂;

where M is a transition metal; and,

where R is Si, Ge, or Ti.

Step 304 discharges the battery. In response to discharging the battery, in Step 306 the solution in the buffer compartment accepts cations from the anode and anions from the cathode. Step 308 forms a cation-anion salt solution in the buffer compartment. In one aspect prior to charging and discharging the battery, Step 302 initially provides a solution in the buffer compartment free of cations and anions.

In Step 307a the first membrane prevents the transportation of anions from the buffer compartment to the anode. In Step 307b the second membrane prevents the transportation of cations from the buffer compartment to the cathode. In Step 307c the second membrane prevents the transportation of protons from the catholyte to the buffer compartment. In response to preventing the transfer of protons to the buffer compartment, Step 307d prevents the corrosion of the first membrane.

In one aspect, the catholyte provided in Step 302 is a LTMS catholyte, such as FeCl₃.6H₂O and LiNO3, and FeCl₃.6H₂O and LiCl, Mn(NO₃)₃.6H₂O, Mn(NO₃)₂.4H₂O, MnCl₂.4H₂O, FeBr₃.6H₂O, KFe(SO₄)₂.12H₂O, FeCl₃.6H₂O, Fe(NO₃)₃.9H₂O, FeCl₃.2H₂O, Fe(NO₃)₂.6H₂O, FeSO₄.7H₂O, CoSO₄.7H₂O, Co(NO₃)₂.6H₂O, Ni(NO₃)₂.6H₂O, Cd(NO₃)₂.4H₂O, and Cd(NO₃)₂.H₂O. The LTMS catholyte has a liquid phase operating temperature of less than 100 degrees C., and has an operating voltage range responsive to the pH value of the LTMS, which is less than 7. The pH remains at a value of less than 7 regardless of whether the battery is charged or discharged, as protons don't participate in the electrochemical reactions.

A battery with a corrosion resistant ion-exchange membrane system has been provided. Examples of catholyte and anode materials have been presented to illustrate the invention. However, the invention is not limited to merely these examples. Other variations and embodiments of the invention will occur to those skilled in the art.

We claim:

1. A battery with a corrosion-resistant ion-exchange membrane system, the battery comprising:
a cathode comprising an acidic catholyte;
an anode comprising a metal that is chemically reactive towards water:
an ion-exchange membrane system comprising:
a solid, cation-permeable, water-impermeable first membrane adjacent to the anode, prone to decomposition upon chemical reaction with an acid;
an anion-permeable second membrane adjacent to the cathode; and,
a buffer compartment, interposed between the first membrane and the second membrane, comprising a solution of materials including cations from the anode and anions from the cathode.

2. The battery of claim 1 wherein the cathode comprises a cathode compartment containing a low temperature molten salt (LTMS) catholyte.

3. The battery of claim 1 further comprising:
an anode compartment comprising:
the anode metal; and,
an electrolyte.

4. The battery of claim 1 wherein the anode metal is selected from the group consisting of alkali metals, alkaline earth metals, and aluminum (Al).

5. The battery of claim 2 wherein the LTMS catholyte has a liquid phase operating temperature of less than 100 degrees C.

6. The battery of claim 2 wherein the battery has an operating voltage range responsive to the pH value of the LTMS catholyte.

7. The battery of claim 6 wherein the LTMS has a pH value of less than 7.

8. The battery of claim 2 wherein the LTMS catholyte is selected from the group consisting of FeCl₃.6H₂O and LiNO3, and FeCl₃.6H₂O and LiCl, Mn(NO₃)₃.6H₂O, Mn(NO₃)₂.4H₂O, MnCl₂.4H₂O, FeBr₃.6H₂O, KFe(SO₄)₂.12H₂O, FeCl₃.6H₂O, Fe(NO₃)₃.9H₂O, FeCl₃.2H₂O, Fe(NO₃)₂.6H₂O, FeSO₄.7H₂O, CoSO₄.7H₂O, Co(NO₃)₂.6H₂O, Ni(NO₃)₂.6H₂O, Cd(NO₃)₂.4H₂O, and Cd(NO₃)₂.H₂O.

9. The battery of claim 2 wherein the first membrane is selected from the group consisting of Li_{1+X}Al_{X}Ti_{2-X}(PO₄)₃ (LATP), Li₇La₃Zr₂O₁₂ (LLZO), Li_{X}PO_{Y}N_{Z} (LiPON), LiₓLa_{2/3-x}TiO₃ (LLTO), Li₁₀GeP₂O₁₂ (LGPS), Na₂M₂TeO₆, beta-alumina, Na₁₊ₓZr₂SiₓP₃₋ₓO₁₂, metal-organic frameworks (MOFs), (1−x)Mg(NO3)2−xAl2O3, magnesium zirconium phosphates, Al₂(WO₄)₃, KSbO₃, NaSbO₃, K₁₋ₓAl₁₋ₓRₓO₂, and NaₓAl_{y}R_{z}O₂;
where M is a transition metal; and,
where R is selected from the group consisting of silicon (Si), germanium (Ge), and titanium (Ti).

10. The battery of claim 2 wherein the cathode is a flow-through cathode comprising:
a cathode compartment including an input flow port, and an output flow port; and,
a reservoir including LTMS catholyte, connected to the input and output flow ports.

11. The battery of claim 10 further comprising:
a pump connected between the cathode compartment and the reservoir to supply a flow of LTMS catholyte from the reservoir in response to a condition selected from the group consisting of the LTMS catholyte in the cathode compartment becoming discharged below a minimum threshold voltage, and the LTMS catholyte in the cathode compartment becoming charged above a maximum threshold voltage.

12. A method for transporting ions in a battery having a corrosion-resistant ion-exchange membrane system, the method comprising:
providing a battery comprising a cathode including an acidic catholyte, an anode including a metal that is chemically reactive towards water, and an ion-exchange membrane system comprising a solid, cation-permeable, water-impermeable first membrane adjacent to the anode, prone to decomposition upon chemical reaction with an acid, an anion-permeable second membrane adjacent to the cathode, and a buffer compartment including a solution, interposed between the first membrane and the second membrane;
discharging the battery;
in response to discharging the battery, the solution in the buffer compartment accepting cations from the anode and anions from the cathode; and,
forming a cation-anion salt solution in the buffer compartment.

13. The method of claim 12 wherein the catholyte is a low temperature molten salt (LTMS) catholyte.

14. The method of claim 12 further comprising:
the first membrane preventing the transportation of anions from the buffer compartment to the anode.

15. The method of claim 12 further comprising:
the second membrane preventing the transportation of cations from the buffer compartment to the cathode.

16. The method of claim 12 further comprising:
the second membrane preventing the transportation of protons from the catholyte to the buffer compartment; and,
in response to preventing the transfer of the protons to the buffer compartment, preventing corrosion of the first membrane.

17. The method of claim 12 wherein the anode metal is selected from the group consisting of alkali metals, alkaline earth metals, and aluminum (Al).

18. The method of claim 13 wherein the LTMS catholyte has a liquid phase operating temperature of less than 100 degrees C.

19. The method of claim 13 wherein the battery has an operating voltage range responsive to the pH value of the LTMS catholyte.

20. The method of claim 19 wherein the LTMS catholyte has a pH value of less than 7.

21. The method of claim 13 wherein the LTMS catholyte is selected from the group consisting of FeCl₃.6H₂O and LiNO3, and FeCl₃.6H₂O and LiCl, Mn(NO₃)₃.6H₂O, Mn(NO₃)₂.4H₂O, MnCl₂.4H₂O, FeBr₃.6H₂O, KFe(SO₄)₂.12H₂O, FeCl₃.6H₂O, Fe(NO₃)₃.9H₂O, FeCl₃.2H₂O, Fe(NO₃)₂.6H₂O, FeSO₄.7H₂O, CoSO₄.7H₂O, Co(NO₃)₂.6H₂O, Ni(NO₃)₂.6H₂O, Cd(NO₃)₂.4H₂O, and Cd(NO₃)₂H₂O.

22. The method of claim 13 wherein the first membrane is selected from the group consisting of Li_{1+X}Al_{X}Ti_{2-X}(PO₄)₃ (LATP), Li₇La₃Zr₂O₁₂ (LLZO), Li_{X}PO_{Y}N_{Z} (LiPON), LiₓLa_{2/3-x}TiO₃ (LLTO), Li₁₀GeP₂O₁₂ (LGPS), Na₂M₂TeO₆, beta-alumina, Na₁₊ₓZr₂SiₓP₃₋ₓO₁₂, metal-organic frameworks (MOFs), (1−x)Mg(NO3)2−xAl2O3, magnesium zirconium phosphates, Al₂(WO₄)₃, KSbO₃, NaSbO₃, K₁₋ₓAl₁₋ₓRₓO₂, and NaₓAl_{y}R_{z}O₂;
where M is a transition metal; and,
where R is selected from the group consisting of silicon (Si), germanium (Ge), and titanium (Ti).

23. The method of claim 12 further comprising:
prior to charging and discharging the battery, initially providing a solution in the buffer compartment free of cations and anions.
